(19) United States
(12) Patent Application Publication
(10) Pub. No.: US 2013/0286869 A1
(43) Pub. Date: Oct. 31, 2013

(54) LAWFUL INTERCEPTS

(71) Applicant: NOKIA SIEMENS NETWORKS OY, Espoo (FI)

(72) Inventors: Roland Antonius WOELKER, Espoo (FI); Mikko Tapani SUNI, Espoo (FI)

(21) Appl. No.: 13/847,720

(22) Filed: Mar. 20, 2013

Related U.S. Application Data
(60) Provisional application No. 61/613,680, filed on Mar. 21, 2012.

(51) Int. Cl. H04L 29/06

(52) U.S. Cl. CPC H04L 63/30
USPC 370/252

(57) ABSTRACT

A method is provided. The method comprises monitoring a radio access network connection with a user. Intercept information associated with the connection is caused to be provided.

### CROSS REFERENCE TO RELATED APPLICATION

This application is related to and claims the priority of U.S. Provisional Patent Application Ser. No. 61/613,680, filed on Mar. 21, 2012, the contents of which are hereby incorporated by reference in their entirety.

### FIELD OF INVENTION

The present application related to interception and particularly but not exclusively to the lawful interception of data.

### BACKGROUND

A communication system can be seen as a facility that enables communications between two or more entities such as a communication device, e.g. mobile stations (MS) or user equipment (UE), and/or other network elements or nodes, e.g. Node B or base transceiver station (BTS), associated with the communication system. A communication system typically operates in accordance with a given standard or specification which sets out what the various entities associated with the communication system are permitted to do and how that should be achieved.

Wireless communication systems include various cellular or otherwise mobile communication systems using radio frequencies for sending voice or data between stations, for example between a communication device and a transceiver network element. Examples of wireless communication systems may comprise public land mobile network (PLMN), such as global system for mobile communication (GSM), the general packet radio service (GPRS) and the universal mobile telecommunications system (UMTS).

A mobile communication network may logically be divided into a radio access network (RAN) and a core network (CN). The core network entities typically include various control entities and gateways for enabling communication via a number of radio access networks and also for interfacing a single communication system with one or more communication systems, such as with other wireless systems, such as a wireless Internet Protocol (IP) network, and/or fixed line communication systems, such as a public switched telephone network (PSTN). Examples of radio access networks may comprise the UMTS terrestrial radio access network (UTRAN) and the GSM/EDGE radio access network (GERAN).

A geographical area covered by a radio access network is divided into cells defining a radio coverage provided by a transceiver network element, such as a Node B. A single transceiver network element may serve a number of cells. A plurality of transceiver network elements is typically connected to a controller network element, such as a radio network controller (RNC). The logical interface between an RNC and a Node B, as defined by the third generation partnership project (3GPP), is called as an Iub interface.

A user equipment or mobile station may be provided with access to applications supported by the core network via the radio access network. In some instances a packet data protocol context may be set up to provide traffic flows between the application layer on the user equipment and the application supported by the core network.

A requirement of some networks is the provision of lawful interception capabilities. In lawful interception, communication data on the network is intercepted and provided to a lawful authority. The lawful authority can analyse the data with regards to any lawful issues that may arise.

### SUMMARY OF INVENTION

According to a first aspect, there is provided a method comprising: monitoring a radio access network connection with a user; and causing intercept information associated with the connection to be provided.

The connection may be between an application provided by a radio access network and the user. The application may be provided by a radio access network server. The radio access server may be integrated with one of: a radio network controller and a base station.

The radio access network server may comprise an application integrated with a radio access network controller. The radio access network server may be configured to provide logical radio access network controller functionality. The radio access server may provide a selective traffic offload to and/or from the radio access network server.

The connection may comprise application traffic. The application may further be provided by a core network. The intercept information may be provided to a lawful intercept gateway. The intercept information may be application traffic.

The method may further comprise identifying the user. The method may further comprise: receiving an identifier of the user from a lawful intercept gateway. The identifier may be at least one of: an international mobile subscriber identifier IMSI and network service access point identifier NSAPI.

The connection may be a part of a packet data protocol PDP context. The connection may be a traffic flow. The lawful intercept information may comprise locally modified, generated and/or terminated traffic. The locally modified, generated and/or terminated traffic may be traffic modified, generated and/or terminated by the radio access network. The locally modified, generated and/or terminated traffic may be modified, generated and/or terminated by an application provided by the radio access network.

The information provided may be encrypted. The information may be caused to be provided over a dedicated encrypted tunnel. The method may further comprise: receiving encrypted information.

According to a second aspect, there is provided an apparatus comprising at least one processor and at least one memory including computer code for one or more programs, the at least one memory and the computer code configured, with the at least one processor, to cause the apparatus at least to: monitor a radio access network connection with a user; and cause intercept information associated with the connection to be provided.

The connection may be between an application provided by the radio access network and the user. The apparatus may be a radio access network server and is further caused to provide the application. The apparatus may be integrated with one of: a radio network controller and a base station.

The apparatus may comprise an application integrated with a radio access network controller. The apparatus may be further caused to provide logical radio access network controller functionality. The apparatus may be further caused to provide a selective traffic offload to and/or from the radio access network server.

The connection may comprise application traffic. The application may be further provided by a core network. The apparatus may be further caused to provide the intercept information to a lawful intercept gateway. The intercept information may be application traffic.

The apparatus may be further caused to identify the user. The apparatus may be further caused to: receive an identifier of the user from a lawful intercept gateway. The identifier may be at least one of: an international mobile subscriber identity IMSI and network service access point identifier NSAPI.

The connection is a part of a packet data protocol PDP context. The connection may be a traffic flow. The intercept information may comprise locally modified, generated and/or terminated traffic. The locally modified, generated and/or terminated traffic may be traffic modified, generated and/or terminated by the radio access network. The locally modified, generated and/or terminated traffic may be modified, generated and/or terminated by an application provided by the radio access network.

The apparatus may further comprise: a first interface for receiving control information; and a second interface for providing the intercept information associated with the connection. The control information of the first interface may correspond to an activation or deactivation of monitoring an identified user.

The information provided may be encrypted. The information may be caused to be provided over a dedicated encrypted tunnel. The apparatus may be further configured to receive encrypted information. The apparatus may further comprise a trusted platform with secure boot and software and/or hardware verification.

According to a third aspect, there may be provided an apparatus comprising: processing means configured to monitor a radio access network connection with a user; and means for causing intercept information associated with the connection to be provided.

According to a fourth aspect, there may be provided an apparatus comprising at least one processor and at least one memory including computer code for one or more programs, the at least one memory and the computer code configured, with the at least one processor, to cause the apparatus at least to: identify a target user to be monitored; and receive information associated with a radio access network connection with the user. The apparatus may be a lawful interception gateway.

According to a fifth aspect, there may be provided, a method comprising: identifying a target user to be monitored; and receiving information associated with a radio access network connection with the user.

The method may further comprise: aggregating interfaces of multiple radio access network RAN nodes; combining and correlating the information with other information from; and providing country specific interfaces towards authorities.

### BRIEF DESCRIPTION OF ACCOMPANYING FIGURES

FIG. 1 shows a network;

FIG. 2 shows a network in accordance with an embodiment;

FIG. 3 shows method steps in accordance with an embodiment;

FIG. 4 shows a network in accordance with a further embodiment;

FIG. 5 shows an interface diagram in accordance with some embodiments; and

FIG. 6 shows method steps in accordance with a further embodiment;

FIG. 7 shows an apparatus; and

FIG. 8 shows a network.

Embodiments of the present application are concerned with the provision of lawful intercept capabilities in a telecommunications network.

Embodiments may be used where there are local break out and off load solutions. This may be in the context of a 3GPP radio environment or any other suitable environment. In some embodiments, applications may be deployed to offload points using for example cloud style application deployments.

Local breakout function may provide a mechanism to serve traffic by local applications. In other words, Internet content or the like is brought to a local breakout point. There are many use cases of localization. By way of example, this may be one or more of a local content delivery network (CDN), local transparent caching, local content optimization for a mobile terminal and/or network, local hosting of other kind of services (used by mobile terminals), and local serving of machine-to-machine (M2M) terminals, for example aggregation functions or the like.

Local breakout may be applied alternatively or additionally to other types of radio networks, such as Wi-Fi, WiMax and Femto network. In such embodiments the offload may be between core network and Internet transit/peering.

Currently, local breakout devices or mobile gateways may be separate from radio devices and application servers. The local breakout devices or mobile gateways currently need to be connected and integrated with complex type solutions through site transport infrastructure. With integration, the traffic routing policy may ensure that the intended application traffic is separated from the other traffic and that the traffic routing policy is in synchronization with the availability or life-cycle of an application.

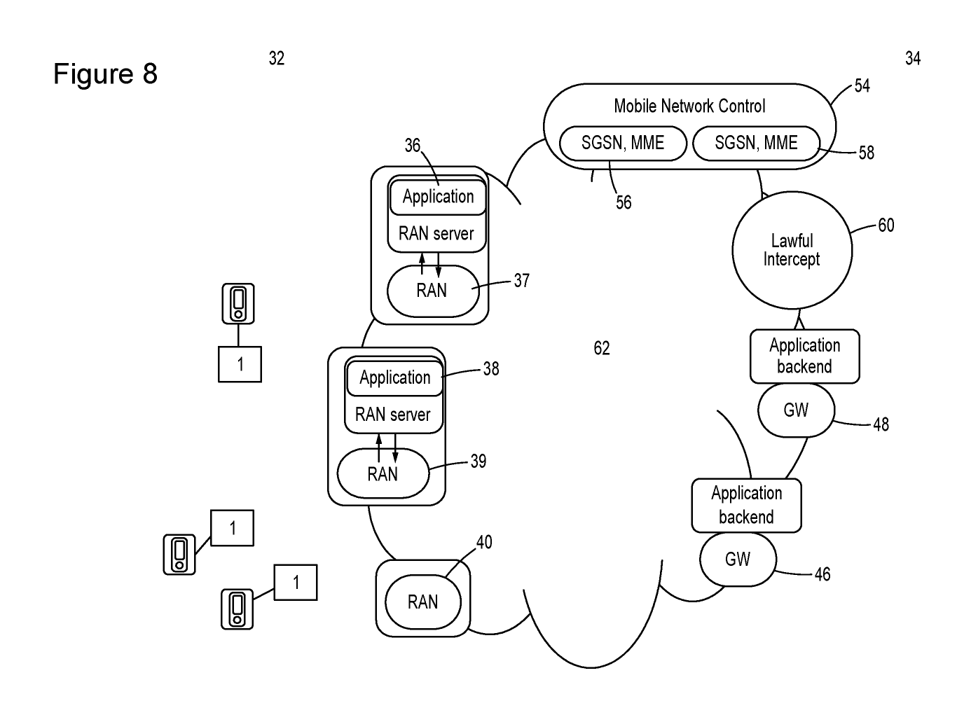

Reference is now made to FIG. 8 which shows one example of a distributed off load deployment scenario in an embodiment. In this example, an application server may be integrated at the RAN level with an off load capability. The application backend in FIG. 8 refers to applications which may have distributed and centralized components.

The network architecture broadly comprises a radio access side 32 and a mobile packet core 34. The radio access side comprises user equipment 1. The user equipment are configured to communicate with a respective radio access network. In FIG. 8, the first radio access network RAN 37, the second radio access network 39 and a third radio access network 40 are shown. Each RAN may comprise a plurality of access nodes. The access nodes may comprise any suitable access node. Depending on the standard involved, the access node may be a base station such as a node B or an enhanced node B. The latter refers to the Long Term Evolution (LTE) of the Universal Mobile Telecommunications System (UMTS) standardized by 3GPP (Third Generation Partnership Project). A controller for the base stations may be provided. In some standards, the controller may be a radio network controller. The radio network controller is able to control the plurality of base stations. In other embodiments, a distributed control function is provided and each base station incorporates part of that control function.

The first radio access network 37 comprises an RAN server integrated with an I-HSPA (Internet-High Speed Packet Access) base station 36 or any other type of base station. The RAN server comprises an application server functionality.

The second radio access network 39 has a RAN server integrated with an RNC 38.

It should be appreciated that other embodiments are additionally or alternatively envisaged such as where application functionality is integrated into a node of the RAN, for example the RNC or the base station, without a server. In some embodiments, a physical realization would be a RNC/base station plus application server in a same integrated hardware. In some embodiments the physical realization or hardware may be different. So a physical realization may be different (for example an integrated one), even though the software functionality may be the same or similar, in some embodiments.

The mobile packet core 34 comprises mobile gateway node 46 and 48. The mobile packet core 34 also comprises a mobile network control part 54. This part comprises SGSNs (serving GPRS (General Packet Radio Service) Support Node) and MMEs (mobile management entities) entities 56 and 58.

In some embodiments, the mobile packet core 34 may comprise a lawful intercept function which allows authorised authorities to monitor communications. This will be described in more detail later.

The radio access part 32 is able to communicate with the mobile packet core via connectivity and transport function 62.

Pass through applications are ones which pass end to end packet flows through modified or un-modified, potentially altering the scheduling of the packets. These are sometimes called virtual appliances. A pass through application may be a virtual machine image with complete application functionality, such as a server containing a transparent cache. Terminating applications are applications which terminate end to end packet flows, providing a service and are therefore visible as IP flow endpoints to terminals using the network. The terminating application may be a virtual machine image with complete application functionality such as a server for a content delivery network. Analytics applications are applications which need to see end to end packet flows but do not modify the packet content or flow scheduling.

When transparent applications deployed as virtual machines are deployed in an Gi/SGi interface, they may be connected normally either as transparent L2 bridges or as L3 next hop routers. Terminating applications may be connected normally by using L3/L4 policy routing. In some environments, the virtual appliances may be deployed as separate servers or clusters of servers, for example a bladed system. The integration may be done with the help of transport nodes, utilizing routers, switches or both.

Some embodiments may provide an application server or application server platform. Some embodiments may use traffic off load. By way of example only, some embodiments may use SIPTO (selected IP traffic off load). SIPTO may for example allow Internet traffic to flow from a femto cell directly to the Internet, bypassing the operator's core network. However, it should be appreciated that SIPTO is one example of traffic off load and other embodiments may alternatively or additionally be used with any other traffic off load.

Some embodiments may be used with applications using a local breakout. The local breakout point maybe in a mobile radio access network. An application may be integrated into a UTRAN or eUTRAN network element or in a server that is connected or coupled to UTRAN or eUTRAN network element.

Some embodiments may alternatively or additionally be used in a Gi/SGi interface of a 3GPP mobile network, applications being integrated into a mobile packet gateway and/or applications running in a server which is connected or coupled to a mobile packet gateway.

Other embodiments may be used in any other suitable situation. For example some embodiments may be used in the demilitarized zone at the border between a private and a public network, or the like.

Embodiments may use a virtual networking interface for offload traffic. This interface may be capable of hosting pass through, terminating and/or analytics applications.

“Local breakout” scenarios provide the system with the ability to select specific IP flows and route them to the local network, as opposed to tunnelling them to the home network. By way of example, such a scenario is described in 3GPP rel 10 under the name SIPTO (selected IP traffic offload, 3GPP TR 23.829 v10.1). SIPTO

So-called “leaky bearer” traffic flow break-out, which may sometimes be called Traffic Offload Function (TOF) allows the extracting or inserting of IP flows of an existing PDP context according to pre-configured traffic filters at for example the RNC or at an Iu interface of the radio access network. By way of example such a Traffic Offload Function (TOF) is described in (Section “5.5 Solution 4: Selected IP Traffic Offload at Iu-PS” of TR 23.829). The terms Traffic Offload Function and “leaky bearer” may be used interchangeably.

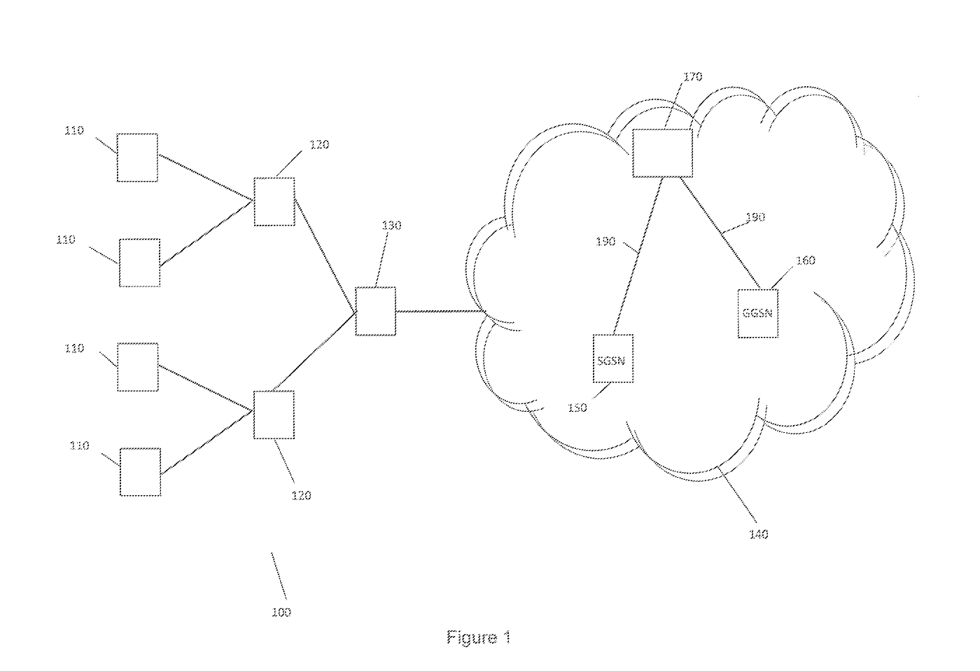

FIG. 1 shows an example of a network comprising a radio access network RAN and a core network CN. The network comprises a plurality of mobile stations 110. The mobile stations 110 may be in communication with one or more access points 120. It will be appreciated that an access points may be for example, a base station, nodeB or eNodeB in some embodiments. The access points 120 may be in communication with a radio network controller 130.

While two mobile stations 110 have been depicted with each access point controller 120 and each access point controllers 120 in communication with one radio network controller 130, it will be appreciated that more or less of these entities may be provided. Additionally, the access point controllers may include the functionality of the radio network controller 130 and may be provided as a single entity.

The radio network controller 130 may communicate with the core network 140. The core network comprises a serving GPRS support node SSGN 150, a gateway GPRS support node 160 and a lawful intercept gateway LIG 170. It will be appreciated the core network may contain additional or other nodes.

The SSGN 150 and GGSN 160 may be configured to support services provided to a user of the telecommunications network. Additionally these nodes may provide access to applications within the network as well as applications on other networks.

The SSGN 150 and the GGSN 160 may have access to communication data provided between applications and services and a user. The SSGN 150 and the GGSN 160 may provide lawful intercept information to the lawful interception gateway LIG 170 as discussed above.

For example in a 3GPP 3G network, lawful intercept LI interfaces and respective LI data delivery for packet services is supported by the core network elements like the GGSN 160 and SGSN 150. The SSGN 150 and GGSN 160 may connect via an X interface 180 to the lawful intercept gateway LIG 170 for LI control and LI data delivery.

The LIG 170 may aggregate the LI data received from nodes 150 and 160 and deliver the LI data to the authorities (for example law enforcement monitoring facilities) in country specific formats.

Telecommunication networks may support selected IP traffic offload SIPTO or local breakout as discussed in 3GPP TR 23.829 v10.1. One of the concepts for 3G networks is the so-called “leaky bearer” traffic flow break-out, also called TOF, which is described in section “5.5 Solution 4: Selected IP Traffic Offload at Iu-PS” of TR 23.829.

The so called “leaky bearer” traffic flow break out may allow extracting or inserting traffic flows of an existing PDP context according to pre-configured traffic filters at the radio network controller RNC or at Iu interface of the radio access network. The traffic flows may be internet protocol flows for example http flows.

The traffic flow break out may provide local access to PDP context traffic flows and enables deployment and execution of local applications at the RAN. These applications may be for example like CDN solutions (content delivery), content delivery optimization, caching solutions or others.

The proximity to the radio access network of these local applications may provide features such as location awareness, lower latency and/or access to radio information (for example. radio cell load or radio condition of certain user equipment).

In the “leaky bearer” offload concept, some traffic flows of a PDP context may be offloaded and modified at the radio access network. New content may be created and added to the traffic flows and traffic flows may be terminated by applications integrated in RAN. Some embodiments may provide this functionality at the radio access network controller.

Some traffic flows may therefore be modified, generated and/or terminated before nodes on the core network have access to the traffic flows. In this case, the core network may not have full visibility of the PDP context activity, e.g. transferred content, used applications, active usage periods. The nodes 150 and 160 of the core network 170 may therefore not support lawful interception for localized applications at the RAN.

In order to address the capture of lawful interception information, local gateways may be implemented. The local gateways may be small GGSNs close to the RAN. A dedicated PDP context is activated between the UE and the local GGSN. The lawful interception for all traffic of this PDP context is handled by the local GGSN.

However the use of local gateways for lawful interception requires the involvement of the user equipment. Network initiated PDP context setup is seldom allowed due to security issues and complexity of configurations.

In order for the UE to initiate setup of PDP context, the UE should know what traffic or applications are subject to the breakout or so called “leaky bearer”. The UE can then initiate a PDP context to the local gateway for this traffic or application. The UE should also know what the access point name APN is for the breakout.

In this provision of the local gateways an UE would need to support application specific PDP contexts and IP route specific PDP contexts as well as having lots of operator specific configurations. These may not be currently provided on UEs. Additionally the PDP context activation may entail delays and increase signalling load in the network.

Additionally, the number of lawful intercept LI interfaces towards the operator backend lawful intercept gateway LIG system increases significantly as a result of local gateways and considerable integration effort is required for the introduction of larger number of gateways into a network.

Some embodiments may provide a method of causing lawful intercept information to be provided from offload points. Offload points may be for example points on the radio access network which may modify, generate and/or terminate radio flows.

In some embodiments, information from the offload points may be combined with lawful intercept LI information from centralized nodes in the core network. In some embodiments, LI information of an individual user may be combined and correlated from multiple sources, for example several RAN nodes and central GGSN. The set of RAN nodes may be dependent on the mobility of a user

The mechanism of some embodiments may scale to a large number of offload points. For example some embodiments may providing scaling with a large number of RAN nodes.

Some embodiments may address security concerns of LI information collection at radio access network nodes that are placed in non-secured premises. Additionally some embodiments may send only locally modified, generated or terminated traffic of LI targets which may address limited backhaul capacity.

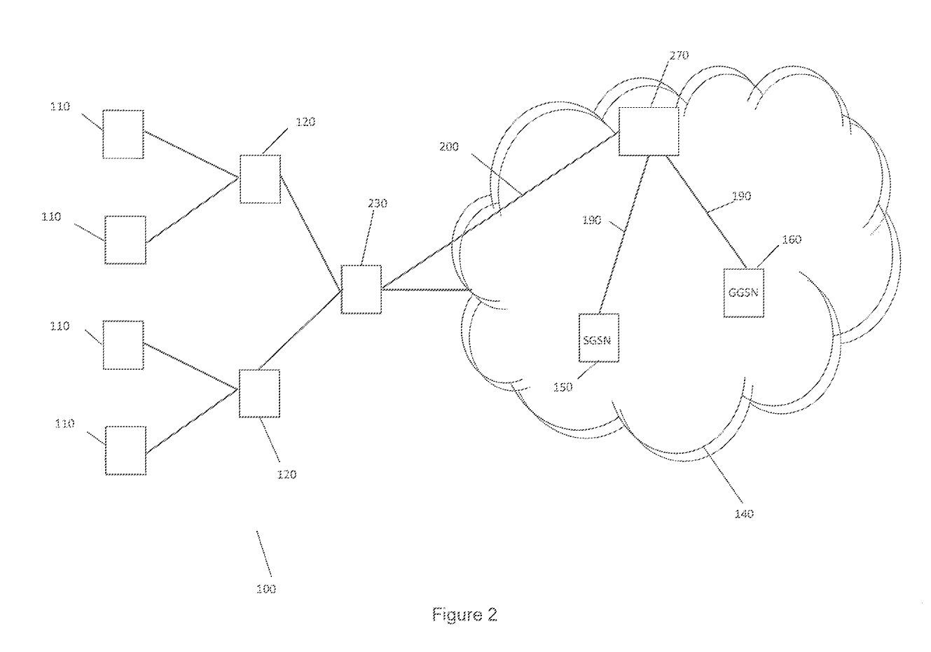

FIG. 2 shows an example of a network in accordance with an embodiment.

The network of FIG. 2 comprises a radio access network 100 and a core network 140. The radio access network 100 comprises user equipment 110, access points 120 and radio network controller 230. The core network 140 comprises serving GPRS support node SGSN150, gateway GPRS support node GGSN 160 and lawful interception gateway LIG 270. The SGSN 150 and GGSN 160 may communicate with the LIG 170 via an X interface 190.

It will be appreciated that the network of FIG. 2 may be similar to the network of FIG. 1.

The radio network controller 230 may communicate to the LIG 270 via an X-interface 200. The network of FIG. 2 may support selective IP traffic offload SIPTO. The radio access network RAN 100 may be able access a connection between a user equipment 110 and the RAN 100. For example the connection may be a traffic flow and the RAN 100 may be able to modify, generate and/or terminate the traffic flow or data carried on the traffic. The RAN 100 may then provide lawful intercept information associated with the connection or traffic flow to the LIG 270 via the X-interface 200.

In the example of FIG. 2, the radio network controller is able to access the connection between a user equipment and the RAN 100, however it will be appreciated that this may be provided by other network entities. For example, the access points 120 may be able to access the connection and/or such functionality may be provided by an additional entity.

The SIPTO or “leaky bearer” functionality, namely the access to a connection between the user equipment and RAN 100 may be provided by a RAN server. The RAN server may be integrated with the RNC 230, access point 120 and/or a separate entity. Alternatively, the RAN server functionality may be provided by the RNC 230.

It will be appreciated that the access points 120, RNC 230 or additionally RAN entities may provide integrated application services for a user equipment.

In embodiments, the RAN server may integrate applications with the RAN 100 by means of introducing an IT server module that hosts applications. The RAN server may be further integrated with RAN node internal interfaces and/or external interfaces, for example Iu/Gn interfaces. The RAN node may be an internet high speed packet access I-HSPA base station (with logical RNC functionality) for example access point 120, RNC 230 or any other node having logical RNC functionality. The RAN server may enable the deployment and execution of local applications. In some embodiments, the RAN server may use the “leaky bearer” offload concept to gain access to the PDP context traffic flows.

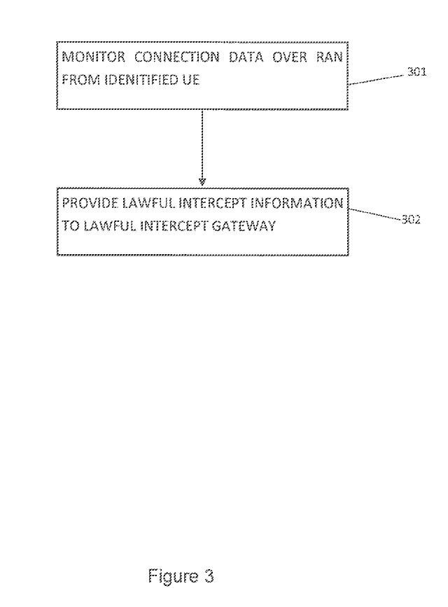

FIG. 3 shows an example of the method steps carried out by embodiments. It will be appreciated that while the steps of FIG. 3 have been described as being carried out by a RAN server at a RNC 230, the steps may be carried out by a RAN server integrated with another entity of the RAN 100 or a RNC 230 having an integrated application.

At step 301 of FIG. 3, the RAN server monitors the communication on a connection between a user equipment 110 and the RAN 100. The connection may for example carry application data. In some embodiments, the connection may be part of PDP context for the user and may correspond to a traffic flow.

The RAN server may be aware of an identity of the user equipment. The user equipment may be a target UE 110 for which data traffic is desired to be intercepted.

At step 302, the RAN server generates lawful intercept information to be sent to the LIG 230. The lawful intercept information may comprise the data traffic on the connection. In some embodiments, the lawful intercept information may comprise only data relating to traffic flows that have been modified, generated or terminated by the RAN 100 and/or application integrated in the RAN 100.

In some embodiments, an application may be located solely at the RAN 100. However in some embodiments, an application located at the RAN 100 may have a backend instance running on the core network.

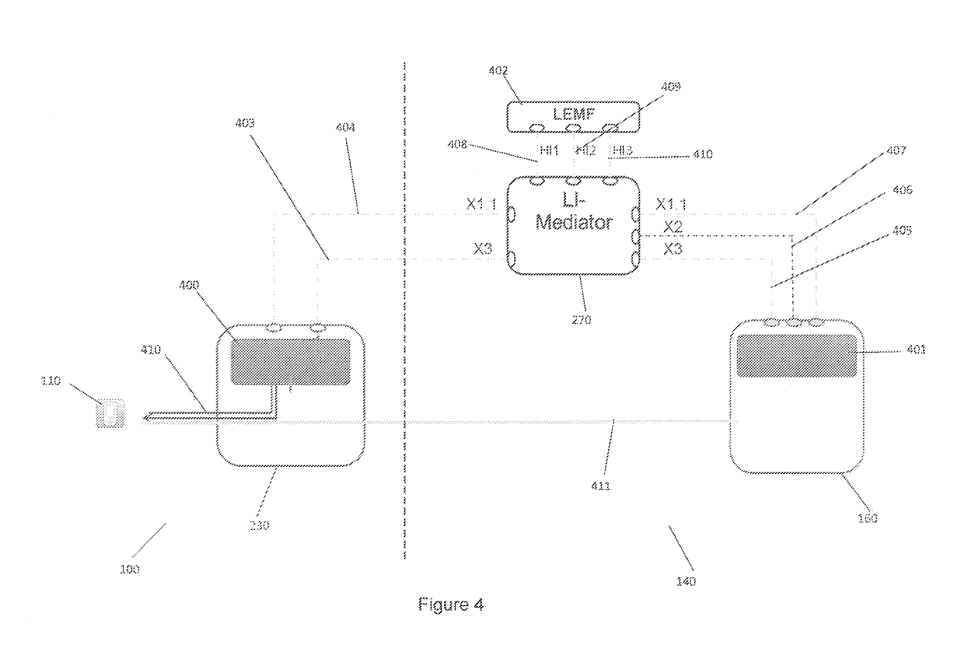

FIG. 4 shows an embodiment with a backend instance for an application. However it will be appreciated that FIG. 4 may be applied to a situation with the application located solely at the RAN with the removal of the application backend entity in the core network.

The network of FIG. 4 comprises a radio access network 100 comprising a user equipment UE 110 and a radio network controller RNC 230. The RNC 230 comprises a RAN server 400 having an integrated application. The network of FIG. 4 further comprises a core network 140. The core network 140 comprises a GGSN 160 having an application backend 401 and a lawful interception mediator 270. The lawful interception mediator 270 communicates with a law enforcement monitoring facility LEMF 402 using country specific formats 408, 409 and 410.

Data from the UE 110 is carried on the RAN 230 via a radio bearer 410. The radio bearer may comprise an uplink and a downlink bearer for carrying application uplink and application downlink data respectively. The radio bearer may be used to carry traffic flows for a PDP context for the UE 110 and application.

A PDP context 411 is shown between the UE 110 and the core network entity 160. In this embodiment, the core network entity is a GGSN, however it will be appreciated that the core network entity may be another node on the core network 140. The GGSN 160 supports an application backend 401 which may provide application services together with the application 400 at the RAN 100 to a user. The PDP context 411 may be set up between the UE 110 and the GGSN 160 over the Gn/Iu interface.

The RAN node 230 (in this case an RNC with an integrated RAN server 400) has an interface with the lawful intercept LI mediator. This may be an X interface. The X interface between the RAN node 230 and the LI mediator may comprise a first interface for example an X1.1 interface and a second interface, for example an X3 interface.

The core network entity 160 has an interface with the LI mediator 270. This may be an X interface. The X interface between the core network entity 106 and the LI mediator 270 comprises a first interface, for example and X1.1 interface, a second interface, for example an X3 interface, and a third interface, for example an X2 interface.

In general the first interface of each of the RAN node 230 and the core network entity 160 is used to provide respective control data and the second interfaces used to provide lawful intercept content. The third interface of the core network entity is used for intercept related information.

The first, second and third interfaces may be X1.1, X3 and X2 interfaces respectively. X1.1 is a LI control interface to activate/deactivate intercept for LI targets. The X2 provided intercept related information IRI data. The X3 interface provides and interface for the transfer of content of communication CC data. An example of the X interface components is shown in table 1.

TABLE 1

| | | X3: Content of |
|---|---|---|
| X1.1: LI control and | | Communication (CC) |
| administration | X2: IRI data | data |
| LI activation/ | Transferred information | Intercepted content of |
| deactivation | target identity | communications |
| Interrogation | the target location (if | Other information |
| Contained information | available) or the IAs | target identity |
| target identities, | in case of location | correlation number |
| e.g. IMSI, NSAPI | dependent | time stamp - |
| information whether | interception | optional |
| the Content of | Correlation number | direction (indicates |
| Communication | Quality of Service | whether T-PDU is |
| (CC) shall be | (QoS) identifier | MO or MT) - |
| provided | events and | optional |
| address of delivery | associated | the target location (if |
| function for the | parameters, e.g. from | available) or the IAs |
| intercept related | GGSN | in case of location |
| information | PDP context | dependent |
| address of delivery | activation; | interception. |
| function for the | PDP context | |
| intercepted content | modification; | |
| of communications | PDP context | |
| IA (interception | deactivation; | |
| area) in the case of | Start of | |
| location dependent | interception with | |
| interception. | PDP context | |
| | active. | |

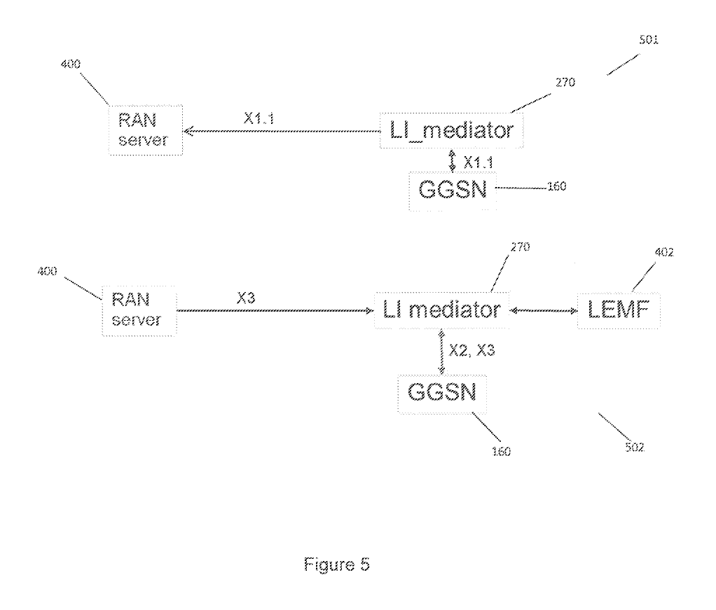

FIG. 5 shows an example of the interfaces between the RAN server 400, core network entity 160, LI mediator 270 and LEMF 402.

501 references the control interface X1.1 between the RAN server 400 and LI mediator 270 and the control interface X1.1 between the core network entity (for example GGSN) and the LI mediator 270. These interfaces may provide data in accordance with the X1.1 interface of table 1.

502 references the content data interface X3 between the RAN server 400 and LI mediator 270 and content data interface X3 between the core network entity (for example GGSN) and the LI mediator 270. An X2 interface is also present between the core network entity 160 and the LI mediator 270. An additional interface is shown between the LI mediator 270 and LEMF 402 which is used for the transfer of accumulated and analysed content data information from the RAN server 400 and core network entity 160. These interfaces may provide data in accordance with the X2 and X3 interface of table 1.

In some embodiments incorporating the RAN server, application traffic over a PDP context between RAN server module 400 and UE 110 is locally modified and/or terminated at the RAN server 400 or originated from the RAN server 400. In some embodiments, no mobile network signalling is modified or terminated at the RAN server 400. Therefore no mobile network signalling IRI data (X2 interface) from the RAN server 400 is provided. In this embodiment, the IRI data can be provided by mobile packet core.

In embodiments, lawful interception of local applications can be covered by supporting the first interface (for example X1.1) to activate/deactivate interception of LI targets (subscribers) and securely copying the application data of LI targets via the second interface (for example X3) to the LI mediator 270.

In some embodiments, lawful intercept data of LI targets may be copied from the RAN 100 side to the LI mediator 270 in a secure manner. The copied LI data may be configured to contain only locally modified, generated or terminated traffic. The LI target may be identified in a variety of ways. For example, a correlation number for providing a link between the LI data and the LI target may be composed of an international mobile subscriber identity IMSI and/or a network service access point identifier NSAPI available at RAN side.

In some embodiments the local LI implementation may be such that LI targets are locally not detectable e.g. by maintenance personnel through management operations at the RAN node. For example, LI related data (targets & intercepted data) may be encrypted.

For example, LI functionality at the RAN side may provide the LI X1.1 and X3 interfaces towards the LI mediator 270 and implement a secure local LI environment. The application data may be securely copied via the X3 interface to the LI mediator 270. This may be over a dedicated, encrypted tunnel. The tunnel may not be shared for other communication purposes. The LI target information may be stored in secure storage. Secure activation/deactivation of intercept for LI targets may be provided. A trusted platform with secure boot and software and/or hardware verification may be provided. This may prevent the use of modified software or hardware to detect LI target information.

The LI mediator 270 may also be provided with secure functionality. For example the LI mediator 270 may aggregate the secure LI interfaces of multiple RAN server nodes (this may potentially be a large number of nodes); combine and correlate the LI data from RAN server side with LI data from other elements; and provide the country specific LI interfaces towards authorities.

It will be appreciated that the LI mediator 270 and/or RAN server 400 may not provide all of the above described features but may provide one or more of the features relating to security.

The foregoing describes a case where the core network elements 140 and RAN 100 are provided by the same vendor. In embodiments where the core elements are from different vendors than the RAN 100 and RAN server 400 (for example there are non-standard X-interfaces) the one of the following may be implemented: a) only RAN servers/elements are connected to the LI mediator and core elements are connect to a separate lawful interception gateway, or b) LI mediator may adapts X interfaces of different vendors.

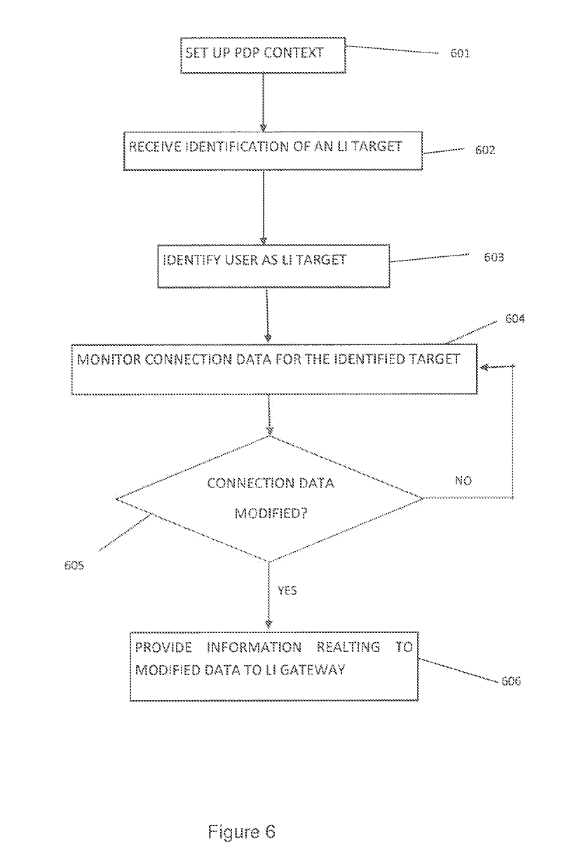

FIG. 6 shows an example of the method steps that may be carried out by some embodiments.

At step 601, a PDP context is set up between a UE 110 and application. The application may be provided by a RAN server 400 and/or by an application backend on a core network entity 160. For example the PDP context may be between a GGSN and UE 110.

At step 602, an identifier identifying a target for lawful interception is received. The identifier may be received by the RAN server 400. In some embodiments, the identifier may be an international mobile station identifier IMSI and/or network service access point identifier NSAPI. The identifier may be received over a first interface of the RAN server 400, for example an X1.1 interface. Other information may be also received over the X1.1 interface for example shown in FIG. 1.

It will be appreciated that steps 601 and 602 may occur in a different order.

At step 603, a UE is identified as a lawful intercept target based on the received identifier. In some embodiments the RAN server 400 may receive an IMSI and/or NSAPI when a PDP context is set up for a user. The IMSI and NSAPI may be used to identify the PDP context in some embodiments. The RAN sever 400 may further receive an identifier from the LI mediator 270 in step 602. The received identifier may then be used to identify a PDP context of the user in order to carry out interception.

At step 604, the RAN server 400 may monitor a connection from the UE identified by the identifier. For example the RAN server 400 may monitor a traffic flow of the PDP context set up in step 601.

At step 604 a determination is made as to whether the communication or connection contains data that has been modified, terminated or generated by the RAN 100. For example, it is determined whether a traffic flow of the UE has been offloaded at the RAN server 400, for example by an integrated application.

If the connection data has not been modified, then the method reverts to step 604 and the connection is further monitored.

If the connection data has been modified, the method continues to step 606. At step 606, lawful intercept information may be generated to be provided to the LI mediator 270. This information may be provided via the second interface (for example the X3 interface) and may be for example be in accordance with table 1. The information may be a copy of the application traffic that has been modified.

It will be appreciated that while the method of FIG. 6 may be carried out by the RAN server or RNC with an integrated application, a core network entity supporting an application backend (if present) may additionally provide lawful intercept information to the LI mediator via a first, second and third interface as shown in FIG. 4. In some embodiments the core network entity may provide a copy of application data to the LI mediator and may not determine whether the data has been modified.

It will be appreciated that modified includes generating or terminating traffic flows or data.

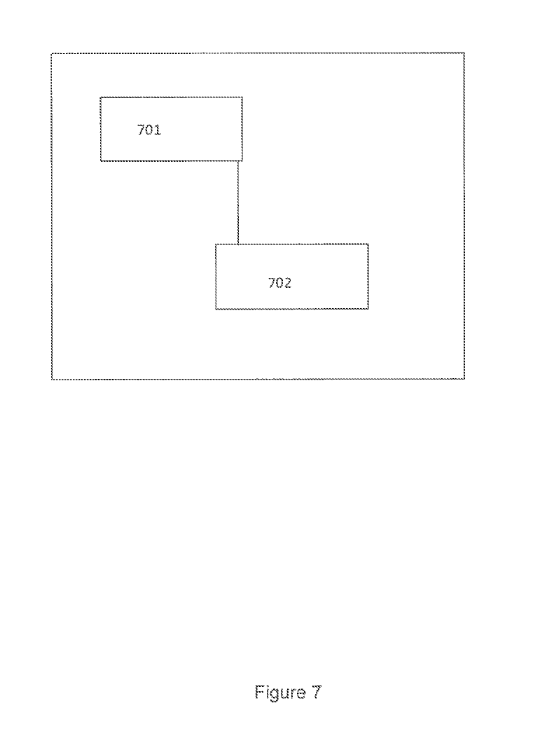

FIG. 7 shows an example of an apparatus that may provide at least some of the method steps of FIG. 3 and/or FIG. 6. The apparatus comprises a memory 702 and a processor 701.

In some embodiments, the apparatus may be a RAN server. The RAN server may form part of an RNC or access point. In other embodiments the RNC may provide the functionality of the RAN server. In some embodiments the functionality of the RAN server may be provided by an processor and a memory of an RNC and/or access point.

It is also noted herein that while the above describes exemplifying embodiments, there are several variations and modifications which may be made to the disclosed solution without departing from the scope of the present invention.

In general, the various embodiments may be implemented in hardware or special purpose circuits, software, logic or any combination thereof. Some aspects of the embodiments may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Some embodiments may be implemented by computer software executable by a data processor of the mobile device, such as in the processor entity, or by hardware, or by a combination of software and hardware.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor-based memory devices, magnetic memory devices and systems, optical memory devices and systems, fixed memory and removable memory.

Furthermore while some embodiments may have been described with entities associated with specific network implementation, for example in accordance with a 3G 3PP network, it will be appreciated that embodiments may be implemented in other networks and by network entities not restricted by a specific network implementation.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed, there is a further embodiment comprising a combination of one or more of any of the other embodiments previously discussed.

1. A method comprising:
monitoring a radio access network connection with a user equipment; and
causing intercept information associated with the connection to be provided.

2. The method as claimed in claim 1, wherein said connection is between an application provided by said radio access network and said user equipment.

3. The method as claimed in claim 2, wherein said application is provided by a radio access network server.

4. The method as claimed in claim 3, wherein said radio access server is integrated with at least one of: a radio network controller and a base station.

5. The method as claimed in claim 3, wherein said radio access network server comprises an application integrated with a radio access network controller.

6. The method as claimed in claim 3, wherein said radio access network server is configured to provide logical radio access network controller functionality.

7. The method as claimed in claim 3, wherein said radio access server provides at least one of a selective traffic offload to said radio access network server and from a selective traffic offload to said radio access network server.

8. The method as claimed in claim 1, wherein said connection comprises application traffic.

9. The method as claimed in claim 1, wherein said application is provided by a core network.

10. The method as claimed in claim 1, wherein said intercept information is provided to a lawful intercept gateway.

11. The method as claimed in claim 1, wherein said intercept information is application traffic.

12. The method as claimed in claim 1, further comprising receiving an identifier of said user equipment from a lawful intercept gateway.

13. The method as claimed in claim 12, wherein said identifier is at least one of: an international mobile subscriber identifier; and network service access point identifier.

14. The method as claimed in claim 1, wherein said connection is a part of a packet data protocol context or said connection is a traffic flow.

15. The method as claimed in claim 10, wherein said lawful intercept information comprises at least one of locally modified, generated and terminated traffic.

16. The method as claimed in claim 15, wherein said at least one of locally modified, generated and terminated traffic is at least one of modified, generated and terminated by at least one of:
said radio access network; and
an application provided by said radio access network.

17. The method as claimed in claim 1, further comprising receiving said information over a dedicated encrypted tunnel, said information being encrypted.

18. A method comprising:
identifying a target user equipment to be monitored; and
receiving information associated with a radio access network connection with the user equipment.

19. The method of claim 18 further comprising:
aggregating interfaces of a plurality of radio access network nodes; and
combining and correlating said information with other information from a core network.

20. The method of claim 19 further comprising providing country specific interfaces towards authorities.

21. A computer program embodied on a non-transitory computer readable medium, comprising code means configured to perform the method as claimed in claim 1.

22. An apparatus comprising at least one processor and at least one memory including computer code for one or more programs, said at least one memory and said computer code configured, with said at least one processor, to cause the apparatus at least to: monitor a radio access network connection with a user equipment; and cause intercept information associated with the connection to be provided.

23. The apparatus as claimed in claim 22 further comprising a first interface for receiving control information and a second interface for providing said intercept information associated with said connection.

24. The apparatus as claimed in claim 23 wherein said control information of said first interface corresponds to at least one of an activation and deactivation of monitoring identified user equipment.

25. The apparatus as claimed in claim 22 further comprising a trusted platform with secure boot and software and/or hardware verification.

26. The apparatus as claimed in claim 22 wherein the apparatus is a lawful interception mediator.

27. An apparatus comprising: processing means configured to monitor a radio access network connection with a user equipment; and means for causing intercept information associated with said connection to be provided.

28. An apparatus comprising at least one processor and at least one memory including computer code for one or more programs, said at least one memory and said computer code configured, with said at least one processor, to cause the apparatus at least to: identify a target user equipment to be monitored; and receive information associated with a radio access network connection with said user equipment.

29. The apparatus as claimed in claim 28 wherein the apparatus is a lawful interception gateway.
